(19) United States
(12) Patent Application Publication
(10) Pub. No.: US 2024/0310815 A1
(43) Pub. Date: Sep. 19, 2024

(54) ALTERATION OF A NON-CONFORMING OBJECT USING THREE-DIMENSIONAL PRINTING

(71) Applicant: International Business Machines Corporation, Armonk, NY (US)

(72) Inventors: Jacob Ryan Jepperson, St. Paul, MN (US); Melanie Dauber, Oceanside, NY (US); Zachary A. Silverstein, Georgetown, TX (US); Logan Bailey, Atlanta, GA (US); Jeremy R. Fox, Georgetown, TX (US)

(21) Appl. No.: 18/122,352

(22) Filed: Mar. 16, 2023

(51) Int. Cl. G05B 19/4099

(52) U.S. Cl. CPC G05B 19/4099; G05B 2219/49023

(57) ABSTRACT

Provided is a method, system, and computer program product for analyzing image data of a non-conforming object in comparison with a digital twin of the same object and generating 3D printable instructions for mitigating the non-conformance. A processor may receive one or more images of a physical copy of a three-dimensional (3D) object. The processor may determine, based on an analysis of the one or more images, one or more differences between the physical copy of the 3D object and a digital twin of the 3D object. The processor may determine that the one or more differences exceed a conformance threshold. The processor may generate, in response to exceeding the conformance threshold, 3D printing instructions for altering the physical copy of the 3D object to reduce the one or more differences.

### BACKGROUND

The present disclosure relates generally to the field of three-dimensional (3D) printing and, more specifically, to analyzing image data of a non-conforming object in comparison with a digital twin of a similar object and generating 3D printable instructions for altering the non-conforming object.

3D printing or additive manufacturing is a process for making a physical object from a 3D digital model (e.g., computer aided design (CAD) drawing or representation, digital twin, etc.) by laying down many successive thin layers of a material using a 3D printing device. In many instances, a 3D printing-based production process circumvents many of the challenges and limitations of traditional manufacturing, especially those that lead to trade-offs between production and design and/or between production and transport. While 3D printers cannot make every imaginable product, the inventory of what can be produced using 3D printing is ubiquitous. For example, 3D printed products include those made from materials as diverse as plastic, metal, and human tissue, and as complex as replacement joints, consumer clothing and engine parts. The number and complexity of products continues to grow rapidly as 3D printing technology evolves.

The availability of 3D printable inventory may be plentiful for product manufacturers, however, when it comes to consumers, the ease of finding replacement parts or ameliorative solutions to fix defective products is lacking. For example, often when ordering items online that need to be assembled (e.g., furniture, mechanical devices, etc.), parts may be received that are either mis-manufactured, or improperly assembled because of human error, resulting in a defective product. This may lead to requiring shipment of additional parts and/or, for some retailers, sending an entire replacement product, resulting in a loss of revenue. However, in many instances, the defective product may be fixed if a simple 3D printing solution was available to the consumer.

### SUMMARY

Embodiments of the present disclosure include a method, system, and computer program product for analyzing image data of a non-conforming object in comparison with a digital twin of a similar object and generating 3D printable instructions for altering the non-conformance. A processor may receive one or more images of a physical copy of a three-dimensional (3D) object. The processor may determine, based on an analysis of the one or more images, one or more differences between the physical copy of the 3D object and a digital twin of the 3D object. The processor may determine that the one or more differences exceed a conformance threshold. The processor may generate, in response to exceeding the conformance threshold, 3D printing instructions for altering the physical copy of the 3D object to reduce the one or more differences. This is more advantageous over standing 3D printing system/methods because the processor, rather than a user, determines the differences between the physical copy of the 3D object and the digital twin. In turn, the processor generates 3D printing instructions for the best solution to mitigate or ameliorate the differences.

In some embodiments, in order to generate 3D printing instruction for altering the physical copy of the 3D object to reduce the one or more differences, the processer may search a digital twin corpus that includes a plurality of ameliorative solutions used to reduce the one or more differences of similar non-conforming objects. The processor may select the ameliorative solution from the plurality of ameliorative solutions that has a highest score for reducing the one or more differences of similar non-conforming objects, and the processor may generate the 3D printing instructions for alerting the physical copy of the 3D object based on the selected ameliorative solution. This is advantageous over standard 3D printing system/methods because the processor automatically identifies the appropriate ameliorative solution for the given non-conforming object rather than a user. Further, the plurality of ameliorative solutions are generated from crowdsourced data, such that the system collects, analyzes, and implements the best solution(s) (e.g., additional pieces or makeshift components that are not part of the original design of the object) that have worked for other users when fixing a non-conforming object, where standard 3D printing/methods only utilize 3D printing of standard parts associated with the original design of the object.

In some embodiments, to select the ameliorative solution from the plurality of ameliorative solutions, the processor may generate simulations of the physical copy of the 3D object with each ameliorative solution of the plurality of ameliorative solutions applied to the physical object to reduce the one or more differences. The processor may analyze changes in the one or more differences as a result of applying each ameliorative solution. The processor may select the ameliorative solution that has a highest value for reducing the one or more differences. This is more advantageous over standard 3D printing systems/methods that lack digital simulation techniques for implementing ameliorative 3D printing solutions to cure defective/non-conforming objects.

In some embodiments, the processor may receive feedback from one or more users indicating that the 3D printing instruction for altering the physical copy of the 3D object reduced the one or more differences. The processor may determine, based on the feedback, an area of the physical object to modify. The processor may update, in response to the determining, the digital twin of the 3D object with the modification to the area. This is more advantageous over standard 3D printing systems/methods because the processor may ingest feedback from users, generate insights based on that feedback, and permanently implement these insights to modify/improve the digital twin model of the 3D, thus preventing non-conformance issues from continuing to occur, which standard 3D printing systems/methods fail to apply any such solutions.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an example 3D printing system, in accordance with embodiments of the present disclosure.

FIG. 2 illustrates an example process diagram for generating 3D printable instructions for altering a non-conforming object, in accordance with embodiments of the present disclosure.

FIG. 3A illustrates image capture of a non-conforming object, in accordance with embodiments of the present disclosure.

FIG. 3B illustrates generation of 3D printable instructions of a second object for altering a non-conforming object, in accordance with embodiments of the present disclosure.

FIG. 3C illustrates an example second object that was generated using 3D printable instruction for altering a non-conforming object, in accordance with embodiments of the present disclosure.

FIG. 4 illustrates a flow diagram of an example process for generating 3D printable instructions for altering a non-conforming object, in accordance with embodiments of the present disclosure.

FIG. 5 illustrates a high-level block diagram of an example computer system that may be used in implementing one or more of the methods, tools, and modules, and any related functions, described herein, in accordance with embodiments of the present disclosure.

FIG. 6 depicts a schematic diagram of a computing environment for executing program code related to the methods disclosed herein and for 3D object analysis, according to at least one embodiment.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to the field of 3D printing and, more particularly, to analyzing image data of a non-conforming object in comparison with a digital twin of a similar object and generating 3D printable instructions for altering the non-conforming object. While the present disclosure is not necessarily limited to such applications, various aspects of the disclosure may be appreciated through a discussion of various examples using this context.

3D printing or additive manufacturing is a process for making a physical object from a 3D digital model (e.g., CAD drawing or representation) by laying down many successive thin layers of a material using a 3D printing device. In many instances, a 3D printing-based production process circumvents many of the challenges and limitations of traditional manufacturing, especially those that lead to trade-offs between production and design and/or between production and transport. While 3D printers cannot make every imaginable product, the inventory of what can be produced using 3D printing is ubiquitous. The availability of 3D printable inventory may be plentiful for product manufacturers, however, when it comes to consumers, the ease of finding replacement parts or ameliorative solutions to fix defective products is lacking.

Embodiments of the present disclosure include a method, system, and computer program product that utilize image/object recognition algorithms to detect a non-conforming or defective object relative to an object specification model (e.g., a digital twin of the same object in a perfect state), abstract the root cause(s) for non-conformity, and generate an ameliorative solution for fixing the non-conforming object using 3D printing.

In embodiments, the system may receive one or more images of a physical copy of a 3D object (e.g., a non-conforming object). The images may be any type of image content depicting the physical copy of the 3D object such as 3D scans, video, and/or static images taken from an image capture device (e.g., 3D scanner, smartphone, table, camera, and the like). For example, a user may generate images (still or video) of a physical object using a smartphone from various angles and upload those images to the system. In some embodiments, the images of the 3D object may be generated and/or received from additional/other devices such as a file server, mobile device, augmented reality (AR) device, and the like, capable of generating and/or sending images of the 3D object.

In embodiments, the system may determine, based on an analysis of the one or more images, one or more differences between the physical copy of the 3D object and a digital twin of the 3D object. For example, the system may utilize various image recognition algorithms or computer vision techniques to identify what type of object is captured in the one or more images and search a digital twin corpus or knowledgebase comprising of a plurality of digital twins to identify a same or substantially similar object. For example, the system may receive images of a defective chair (e.g., a chair having a defective or missing part causing a leg of the chair to be shorter than the other legs) and identify that the images contain a chair. In response to identifying the chair, the system will search a digital twin corpus to find a matching or substantially similar digital twin of the chair. In embodiments, the identified digital twin of the 3D object will be substantially similar to the non-conforming object but in a perfect state (i.e., conforming with the model specifications of the chair without any non-conforming features/attributes). Once the physical object is identified, and a matching digital twin is found, the system will analyze the difference between the actual state of the physical object in the images in comparison with the perfect state of the object form the digital twin.

In embodiments, the system will use image recognition algorithms to extract various features or attributes of the non-conforming object and compare those features/attributes to the features/attributes of the digital twin of the object. The features may include, for example, angles and positioning of certain components (e.g., angle tilt in relation to a floor, loose parts, levelness with the ground), the presence of defects (e.g., dents, damaged areas, wear, missing parts, or components, etc.), color and/or type of material used to construct the object. As would be recognized by one of ordinary skill in the art, other features may be extracted depending on the type of object, and the examples given herein should not be construed as limiting. The system may determine how the features of the physical object in its actual state correspond/compare to the features of the digital twin of the object in the perfect state. Based on the comparison, the system will identify one or more differences (e.g., non-conforming attributes) between the non-conforming object and the digital twin of the object. Returning to the previous example, the system will identify that the defective chair in its actual state has a shorter leg based on a comparison with the digital twin of the chair in a perfect state.

In embodiments, the system may determine which of the one or more differences exceed a conformance threshold. For example, the system may include various thresholds for determining which features/attributes of the given object are non-conforming with respect to features/attributes of the digital twin. This may include attributes related to angle, tilt, one or more missing objects or parts, color, etc. For example, two components of a given object that are assembled perpendicularly may be required to have an angle range of 89-91 degrees when assembled correctly to be within the conformance threshold. A non-conforming object may include loose or defective parts that result in an angle (e.g., 80 degrees) between components that exceeds the conformance threshold. The system may use image recognition algorithms and/or computer vision techniques to identify this non-conformance by comparing and calculating the angles of the components of the non-conforming object in the actual state versus the angles of the components of the digital twin in the perfect state and apply the angle values to a conformance threshold.

In embodiments, based on the detected non-conformance, the system may search the digital twin corpus that includes a plurality of ameliorative solutions for reducing the differences between the non-conforming object and the digital twin of the object. In embodiments, the digital twin corpus may include a plurality of ameliorative solutions or fixes that other users (crowdsourced users) have used to repair or reduce non-conformance of the object or similar objects. In embodiments, the ameliorative solutions may include additional pieces or makeshift components that are not part of the original design of the object. Returning the previous example, the system may identify a bracket that is configured to increase the angle value of the two components of the non-conforming object from 80 degrees to within 89-90 degrees, such that the resulting angle value falls within the conformance threshold. In some embodiments, the identified bracket (i.e., ameliorative solution) may not be included in the original design specification or digital twin of the object in the perfect state but has been identified for use to fix similar non-conformances with similar objects based on analysis of crowdsourced data.

In embodiments, the system may use image analysis algorithms and/or computer vision techniques (e.g., shifting, placing, segmentation, etc.) that accurately predict the orientation of the object when/if the ameliorative solution or fix is applied to alter the one or more differences of the non-conforming object. For example, the system may determine which ameliorative solution of a plurality of ameliorative solutions best reduces the one or more differences between attributes of the non-conforming object and the digital twin of the object by a highest value by digitally simulating the ameliorative solution being applied to the non-conforming object. In some embodiments, the system will rank or apply weights to the ameliorative solutions that have been shown to work best in reducing differences or improving the non-conforming object.

In embodiments, the system may utilize various imaging data related to the object to aide in digitally re-assembling the non-conforming object with various ameliorative solutions applied and select the ameliorative solution that reduces the differences the most. In embodiments, the system may utilize one or more related CAD drawings, reference images (e.g., photographs), and/or blueprints that are associated with the digital twin of the object and/or individual ameliorative solutions obtained through crowdsourced data to aide in generating the simulation of the object.

In embodiments, the system will select the best ameliorative solution and generate 3D printing instructions for altering the physical copy of the 3D object to reduce the one or more differences. In embodiments, the 3D instructions for altering the physical copy of the 3D object will be based on the identified ameliorative solutions that reduces the differences between the non-conforming object and the digital twin object the most. Using the 3D printing instruction, the system can initiate printing of the ameliorative solution using a communicatively couple 3D printing device. Returning to the previous example, the system will select the bracket (based on crowdsourcing and/or simulating which ameliorative solution works best) and generate 3D printing instructions for printing a physical copy of the bracket. In this way, the user can print the bracket and alter the physical copy of the object such that the non-conforming angle falls within the conformance threshold. In this way, the system allows a user to easily produce replacement parts when a 3D digital model of the part is unavailable.

In some embodiments, the user may generate additional images of the physical object with the ameliorative solution being applied and send these images to the system for reanalysis. The system will identify if the ameliorative solution has reduced the given differences in order to fall within the conformance threshold. In some embodiments, the system may use machine learning to track ameliorative solutions that have been made for reoccurring non-conforming objects and identify if the solution(s) should be permanently implemented within the digital twin specifications of the given object. In this way, if a significant number of users are implementing the same ameliorative solutions for a given type of object, the system may automatically update the digital twin to include that given solution. In some embodiments, data content regarding altering the non-conforming object may be shared with the manufacturer of the give object, such that alterations to the design and/or specification of the object may be made.

In embodiments, the system may utilize crowdsourcing to improve the quality of the ameliorative solutions for fixing non-conforming objects. For example, the system may be configured to receive feedback from users that indicate various ameliorative solutions or second objects (e.g., parts) have failed to address non-conformance over time (e.g., a solution that initially fixed the defective product but failed over time). Using the feedback and machine learning, the system can determine areas of the non-conforming object and/or the ameliorative solution that may be altered to permanently prevent further non-conformance. For example, based on the feedback, the system may recommend one or more different printing materials (e.g., based on a tensile strength determination of a set of printing materials, color, type of filament, etc.) to be used when printing the ameliorative solution for fixing the non-conforming object, such that the solution will maintain conformance over a longer period.

In embodiments, the system may store the one or more images of the non-conforming object and the associated 3D printing instructions of the ameliorative solution used to fix the non-conformance within the digital twin corpus or central knowledgebase. These historical image data files and 3D printing instructions may be used and/or leveraged when the system detects similar non-conforming objects or solutions being captured, analyzed, and/or generated in a similar way. In this way, the system may utilize historical data to help make predictions on altering or improving non-conforming objects.

In some embodiments, the user(s) must opt into the system in order for the system to collect, receive, generate, and/or use their information (e.g., generate 3D scans, receive CAD drawings, analyze intellectual property, utilize ameliorative 3D printing instructions, etc.). The user may determine which other users (e.g., third party user, second users, crowdsourced users, etc.) can access the collected data. For example, during an initialization process, the system may inform the user of the types of data that it will collect (e.g., image data, 3D scans, user feedback, 3D printing instructions, etc.) and the reasons why the data is being collected. In these embodiments, the system will only start collecting the user information upon the user explicitly permitting the collection. Furthermore, the system may only collect the data that is necessary to generate the 3D printable instruction for altering the non-conforming object. The data may be anonymized and/or encrypted while in use, and the data may only be maintained as needed for providing necessary actions. If the user chooses to opt out of the system, any user information previously collected may be permanently deleted.

The aforementioned advantages are example advantages, and not all advantages are discussed. Furthermore, embodiments of the present disclosure can exist that contain all, some, or none of the aforementioned advantages while remaining within the spirit and scope of the present disclosure.

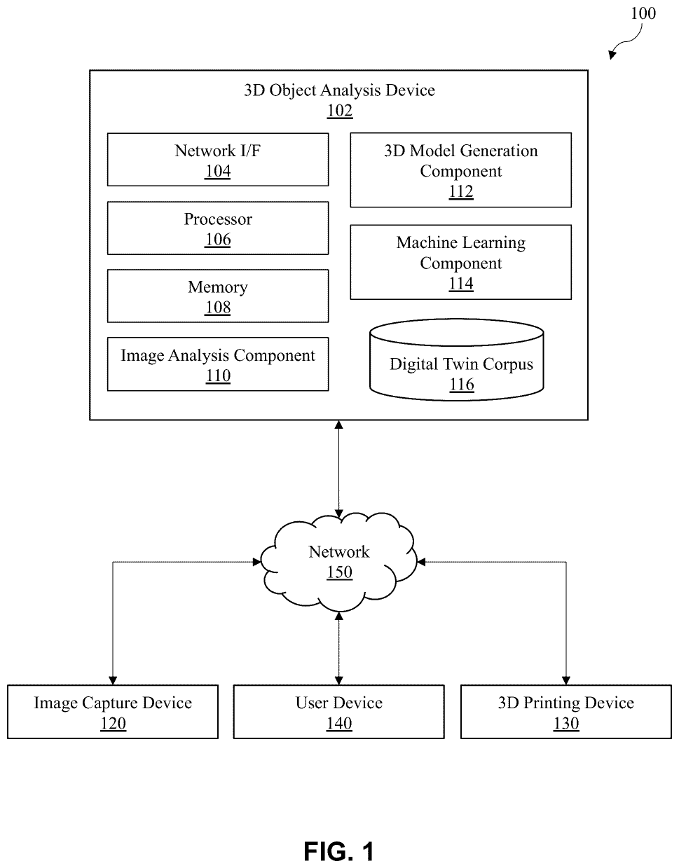

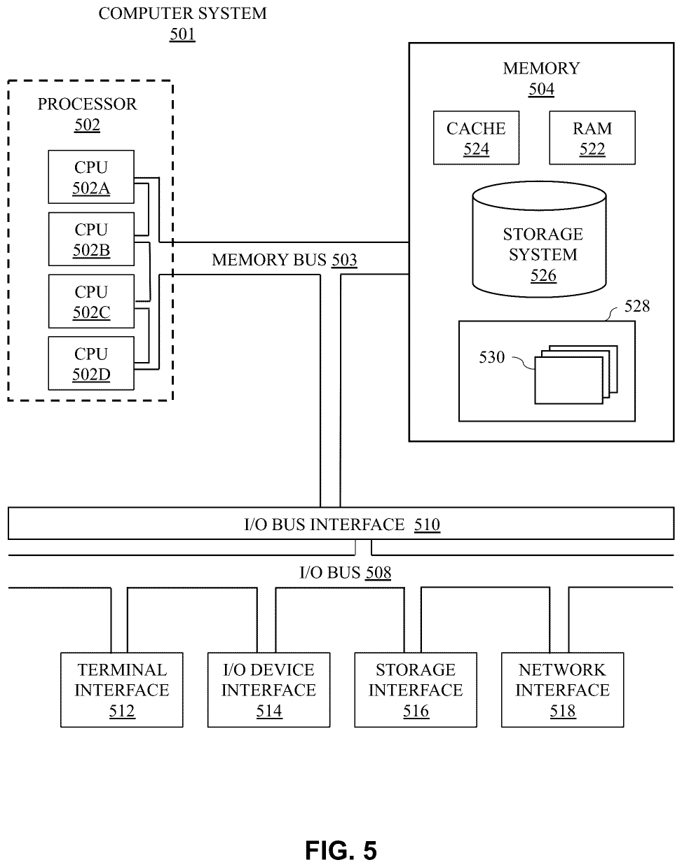

With reference now to FIG. 1, shown is a block diagram of an example 3D printing system 100, in accordance with embodiments of the present disclosure. In the illustrated embodiment, 3D printing system 100 includes 3D object analysis device 102 that is communicatively coupled to image capture device 120, 3D printing device 130, and user device 140 via network 150. 3D object analysis device 102 and user device 140 may be configured as any type of computer system and may be substantially similar to computer system 501 of FIG. 5. In some embodiments, 3D object analysis device 102, image capture device 120, 3D printing device 130, and user device 140 may be configured as separate standalone systems or as one or more integrated system. For example, 3D object analysis device 102 may be included with 3D printing device 130 as an integrated printing system, while image capture device 120 may be included on user device 140, such as an integrated camera on a smartphone. In some embodiments, each device may be separate and communicatively connected to each other over network 150.

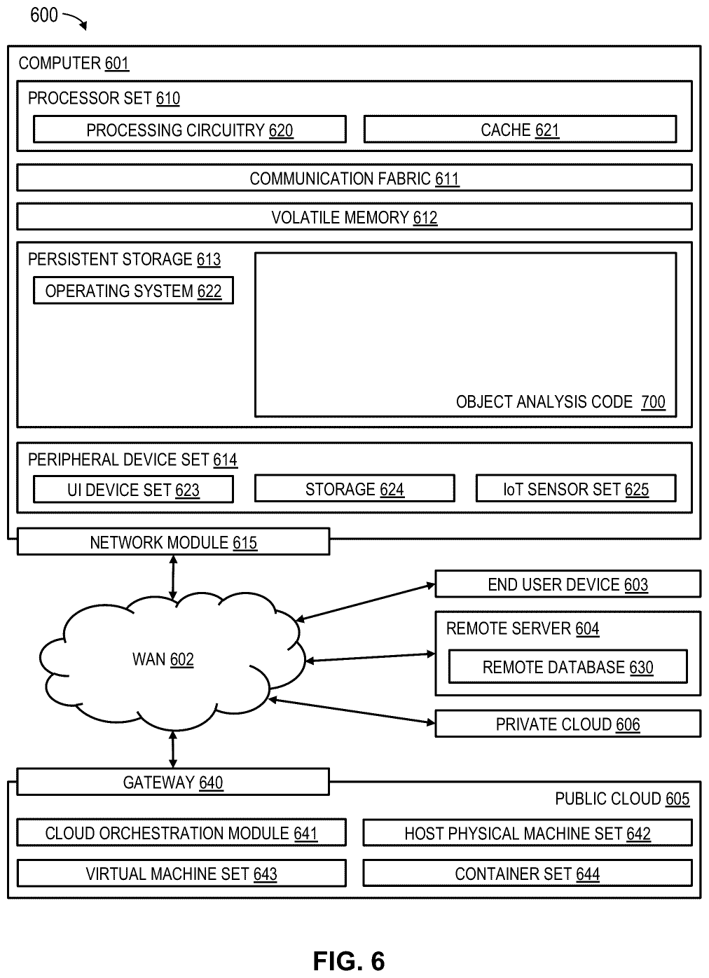

Network 150 may be any type of communication network, such as a wireless network or a cloud computing network. Network 150 may be substantially similar to, or the same as, a computing environment 600 described in FIG. 6. In some embodiments, network 150 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over network 150. In some embodiments, network 150 can be implemented using any number of any suitable communications media. For example, the network may be a wide area network (WAN), a local area network (LAN), a personal area network (PAN), an internet, or an intranet. In certain embodiments, the various systems may be local to each other, and communicate via any appropriate local communication medium. For example, 3D object analysis device 102 may communicate with image capture device 120, 3D printing device 130, and user device 140 using a WAN, one or more hardwire connections (e.g., an Ethernet cable), and/or wireless communication networks. In some embodiments, the various systems may be communicatively coupled using a combination of one or more networks and/or one or more local connections. For example, in some embodiments, 3D object analysis device 102 may communicate with image capture device 120 (e.g., a 3D scanning device) and 3D printing device 130 using a hardwired connection, while communication between user device 140 (e.g., a personal computer, smartphone, tablet, etc.) and 3D object analysis device 102 may be through a wireless communication network.

In embodiments, image capture device 120 may be any type of image generating device (e.g., 3D scanner, Internet of Things (IoT) camera, smart camera, video camera, augmented reality device, etc.) that is configured to generate images of one or more objects. In embodiments, 3D printing device 130 may be any type of printing device (e.g., 3D printer) that is configured to print and/or generate a physical 3D object or physically altering component (e.g., additional layers of printed material added to a non-conforming object). In some embodiments, image capture device 120, user device 140, and 3D printing device 130 may include some or similar components (e.g., processor, memory, machine learning component, corpus, etc.) as 3D object analysis device 102, but for brevity purposes these components are not shown.

In the illustrated embodiment, 3D object analysis device 102 includes network interface (I/F) 104, processor 106, memory 108, image analysis component 110, 3D model generation component 112, machine learning component 114, and digital twin corpus 116.

In embodiments, image analysis component 110 is configured to use various image recognition algorithms to analyze one or more images of a non-conforming object (generated by image capture device 120) in comparison to a digital twin of the object in a perfect state (e.g., digital twin of a similar conforming object). The image analysis component 110 uses the image recognition algorithms to identify one or more differences when compared to a digital twin of the object. The image analysis component 110 may identify what type of object is shown in the one or more images of the non-conforming object and search the digital twin corpus 116 for a digital twin of a same or substantially similar object in a perfect state. Once the physical object is identified, and a matching digital twin is found, the image analysis component 110 will analyze the difference(s) between the actual state of the physical object in the images in comparison with the perfect state of the object form the digital twin.

In embodiments, image analysis component 110 will use image recognition algorithms to extract various features or attributes of the non-conforming object and compare those features/attributes to the features/attributes of the digital twin of the object. The features may include, for example, angles and positioning of certain components (e.g., angle tilt in relation to a floor, loose parts, levelness with the ground), the presence of defects (e.g., dents, damaged areas, wear, missing parts or components, etc.), color and/or type of material used to construct the object. As would be recognized by one of ordinary skill in the art, other features may be extracted depending on the type of object, and the examples given herein should not be construed as limiting. The image analysis component 110 may determine how the features of the physical object in its actual state correspond and/or compare to the features of the digital twin of the object in the perfect state. Based on the comparison, the image analysis component 110 will identify one or more differences between the non-conforming object and the digital twin of the object. Image analysis component 110 may determine which of the one or more differences exceed one or more conformance threshold. The conformance thresholds may be determined using machine learning component 114 by correlating features or attributes of reference images or a digital twin of a similar object with the features/attributes of a non-conforming object. For example, the system may include various thresholds for determining which features/attributes of the given object are non-conforming with respect to features/attributes of the digital twin. This may include attributes related to angle, tilt, one or more missing objects or parts, color, etc. In embodiments, in response to one or more attributes of the object being non-conforming, image analysis component 110 may search digital twin corpus 116 for one or more ameliorative solutions for reducing the differences (measured values related to the features and attributes) between the non-conforming object and the digital twin of the object. In embodiments, the digital twin corpus 116 may include a plurality of ameliorative solutions or fixes that other users (crowdsourced users) have used to repair or reduce non-conformance of the object or similar objects. In embodiments, the ameliorative solutions may include additional pieces or makeshift components that are not part of the original design of the object. In embodiments, the ameliorative solution may be received, retrieved, and/or stored from/on digital twin corpus 116. In some embodiments, digital twin corpus 116 may receive crowdsourced data from one or more other users (e.g., data related to ameliorative solutions that have worked for similar objects) via user device 140.

In embodiments, 3D model generation component 112 is configured to generate 3D printable instructions for printing a selected ameliorative solution. In some embodiments, 3D model generation component 112 may utilize various imaging data related to the object to aide in digitally re-assembling or simulating the non-conforming object with various ameliorative solutions applied thereto, and select the ameliorative solution that is predict to reduce the differences the most. The 3D model generation component 112 may score or rank which solutions reduce differences the most and implement those solutions having the highest score for 3D printing first based on availability of materials. In embodiments, the system may utilize one or more related CAD drawings, reference images (e.g., photographs), and/or blueprints that are associated with the digital twin of the object and/or individual ameliorative solutions obtained through crowdsourced data to aide in generating the simulation of the ameliorated object.

In embodiments, the 3D model generation component 112 will generate 3D printing instructions for altering the physical copy of the 3D object based on the identified ameliorative solution that reduces the differences between the non-conforming object and the digital twin object the most. Using the generated 3D printing instruction, the 3D object analysis device can initiate printing of the ameliorative solution using communicatively coupled 3D printing device 130.

In embodiments, machine learning component 114 may collect, monitor, and/or analyze various data (image capture data, digital twin modeling, crowdsourced ameliorative solutions, CAD drawings, etc.) related to the 3D printing system 100. Using the various data, machine learning component 114 may automatically implement and/or adjust attributes of ameliorative solutions for reducing difference in order for the non-conforming object(s) to meet conformance thresholds. For example, machine learning component 114 may identify from the collected data and/or feedback from users (received via user device 140) that a 3D printed ameliorative solution does not effectively reduce differences between attributes/features of the physical object and the digital twin object to fall within one or more conformance thresholds. The machine learning component 114 can input this data and adjust the ameliorative solution (e.g., dimensions, materials, components of the solution, etc.) until the conformance threshold(s) is/are met. The machine learning component 114 may use crowdsourcing to improve the quality of the ameliorative solutions for fixing non-conforming objects. For example, the system may be configured to receive feedback from users that indicate various ameliorative solutions or second objects (e.g., parts) have failed to address non-conformance over time (e.g., initially fixed the defective product but failed over time). Using the feedback and machine learning, the system can determine areas of the non-conforming object and/or the ameliorate solution that may be altered to permanently prevent further non-conformance. For example, based on the feedback, the machine learning component 114 may recommend that one or more different printing materials (e.g., based on a tensile strength determination of a set of printing materials, color, type of filament, etc.) to be used when printing the ameliorative solution for fixing the non-conforming object that maintain conformance over a longer period of time.

In some embodiments, machine learning component 114 can utilize machine learning and/or deep learning, where algorithms or models can be generated by performing supervised, unsupervised, or semi-supervised training on historical data related to generating ameliorative solutions for altering non-conforming objects (e.g., analyzing images or 3D scans of non-conforming objects, the re-assembled object using the ameliorative solution, etc.) and correlate historical success rates for printing various ameliorative solutions for fixing non-conforming objects. Over time, machine learning component 114 may improve predictions on how to generate accurate ameliorative solutions based on analysis of crowdsourced solitons that result in improvements in fixing defective or non-conforming objects without the need to order replacement parts or new objects. Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBDT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

FIG. 1 is intended to depict the representative major components of 3D printing system 100. In some embodiments, however, individual components may have greater or lesser complexity than as represented in FIG. 1, components other than or in addition to those shown in FIG. 1 may be present, and the number, type, and configuration of such components may vary. Likewise, one or more components shown with 3D printing system 100 may not be present, and the arrangement of components may vary. For example, while FIG. 1 illustrates an example 3D printing system 100 having a single 3D object analysis device 102, a single image capture device 120, a single 3D printing device 130, and a single user device 140 that are communicatively coupled via a single network 150, suitable network architectures for implementing embodiments of this disclosure may include any number of 3D object analysis devices, 3D scanning devices, 3D printing devices, user devices, and networks. The various models, modules, systems, and components illustrated in FIG. 1 may exist, if at all, across a plurality of 3D object analysis devices, 3D scanning devices, 3D printing devices, user devices, and networks.

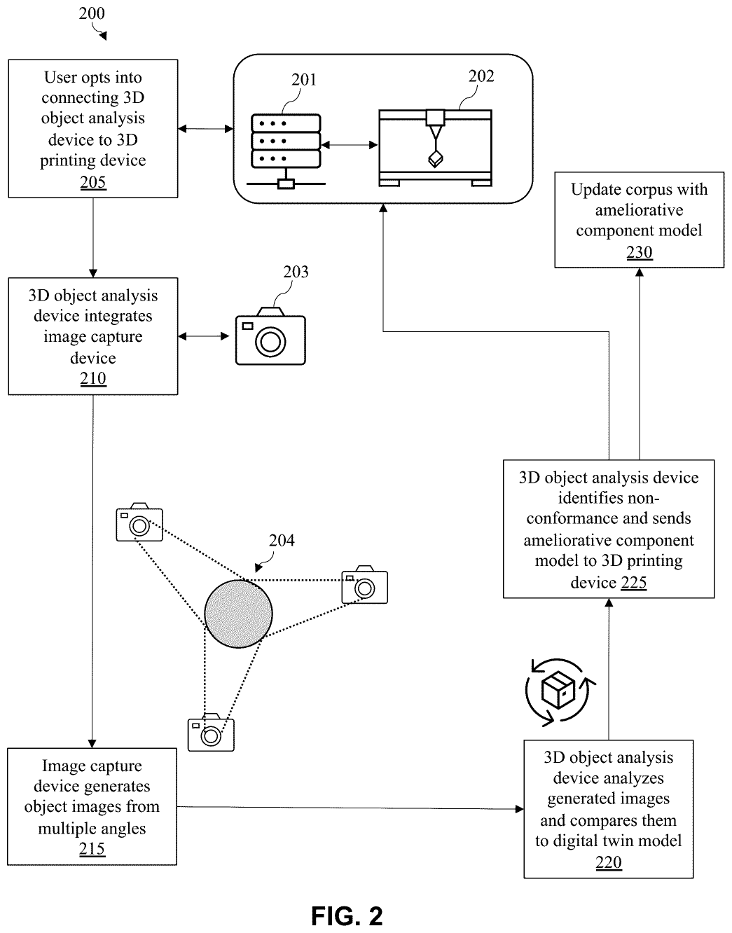

Referring now to FIG. 2, shown is an example process diagram 200 for generating 3D printable instructions for altering a non-conforming object, in accordance with embodiments of the present disclosure. In embodiments, process 200 may be performed by 3D object analysis device 201. In some embodiments, 3D object analysis device 201 may be the same or substantially similar to 3D object analysis device 102 of FIG. 1.

In some embodiments, the process 200 begins by a user opting into connecting the 3D object analysis device 201 to 3D printing device 202. This is shown at step 205. The 3D object analysis device 201 may be a cloud-based computing device or a local device (as described in FIG. 1) that connects to 3D printing device 202.

The process 200 continues by the 3D object analysis device 201 integrating one or more image capture devices 203. This is shown at step 210. The image capture device 203 may be any type of image capture device that is configured to generate images of an object (e.g., non-conforming object). For example, the image capture device 203 may be a smartphone that is communicatively coupled to the 3D object analysis device 201 over a network.

The process 200 continues by generating images of a non-conforming object 204 from multiple/various angles using the image capture device 203. This is shown at step 215. For example, a user may capture various images of the non-conforming object 204 from various angles in order to allow for a proper analysis for the given non-conformance. In some embodiments, the 3D object analysis device 201 may initiate image capture using an automated image capture device without the need for human input (e.g., via an automated system).

The process 200 continues by analyzing the received generated images of the non-conforming object 204 in comparison with a digital twin model of a substantially similar or closely matching object (e.g., a digital twin of the object in a perfect state). In embodiments, the 3D object analysis device 201 may using one or more image recognition algorithms to identify the type of object from the captured images of the non-conforming object 204 and find a matching/similar digital twin of the object from a digital twin corpus. The 3D object analysis device 201 may utilize the image recognition algorithms and/or computer vision techniques to identify/detect difference between the non-conforming object 204 and the digital twin of the object.

The process 200 continues by the 3D object analysis device determining how to best address the differences causing the non-conformance and generating 3D printing instructions for printing an ameliorative solutions or component (second object) using 3D printing device 202. This is shown at step 225. The 3D object analysis device 201 may utilize various crowdsourced ameliorative solutions for mitigating/altering the differences of the non-conforming object. For example, the 3D object analysis device 201 may select an ameliorative solution from the digital twin corpus that has a highest score/ranking/value for reducing the one or more differences in attributes between the non-conforming object and the digital twin of the object.

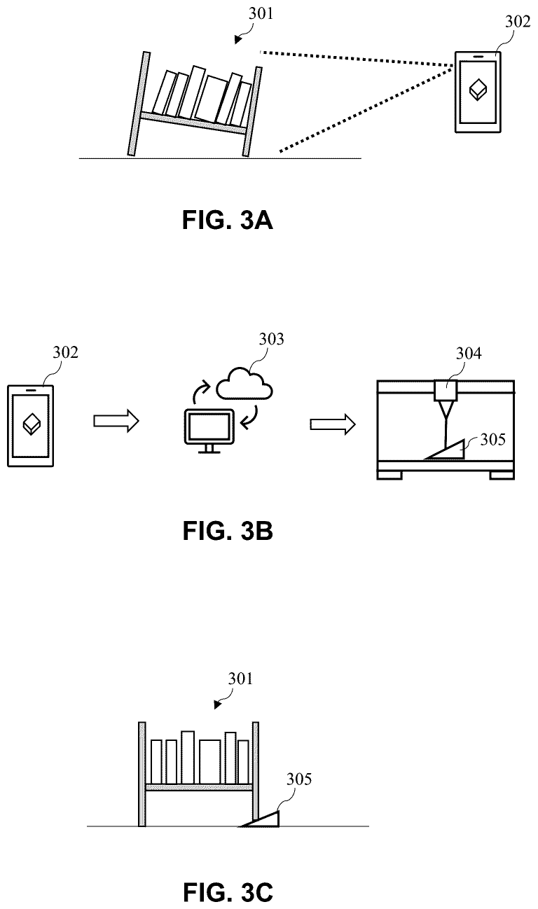

The process 200 continues by updating the digital twin corpus with the 3D instructions for printing the ameliorative component. In this way, the digital twin corpus is continuously updated with 3D instructions that were used to fix various non-conforming objects. In embodiments, the 3D object analysis device 201 may be trained to identified which ameliorative components best fixed the non-conformance by analyzing user feedback and/or analysis a second set of images of the non-conforming object that includes the ameliorative solution/component applied to the non-conforming object. The 3D object analysis device 201 may analyze the second set of images and generate values indicating how various attribute were affected by the ameliorative solution/component. For example, the 3D object analysis device 201 may determine if various conformance thresholds for the object are met resulting from the addition of the 3D printed second object or component. Alteration of an example non-conforming object using process 200 is detailed in FIGS. 3A-3C below.

Referring now to FIG. 3A, shown is image capture of a non-conforming object 301, in accordance with embodiments of the present disclosure. In the illustrated embodiment, the non-conforming object 301 is configured as a bookshelf that is uneven due to a non-conforming leg (e.g., incorrectly sized leg or missing one or more parts). To mitigate or ameliorate the non-conformance, a user captures one or more images of the non-conforming object 301 using an image capture device 302, shown as a smartphone. It is noted that the illustrated embodiment is not meant to be limiting, the type of non-conforming object and/or image capture device may be any type of object or image capture device as would be recognized by one skilled in the art.

Referring now to FIG. 3B, shown is the generation of 3D printable instructions of a second object 305 for altering a non-conforming object, in accordance with embodiments of the present disclosure. In the illustrated embodiment, the image capture device 302 send the images of the non-conforming object 301 to 3D object analysis device 303. The 3D object analysis device 303 may analyze the images of the non-conforming object in comparison with a digital twin of the object in its perfect state to ascertain the differences between the digital twin and the non-conforming object. The 3D object analysis device 303 may generate 3D printable instruction for a second object 305 that may be sent to a 3D printing device 304. For simplicity purposes, the second object 305 is shown as a simple wedge or shim, however, it is contemplated that more complex solutions and/or parts may be identified from the corpus that may be used to ameliorate or reduce non-conformances based on user feedback and/or machine learning. In embodiments, the printed second object 305 may be used to mitigate/alter the non-conforming object 301 in such a way to meet one or more conformance thresholds. For example, the conformance thresholds may be based on various attributes (e.g., angles, tilt, level, parts, shape, measurements, etc.) related to the perfect state of the object in the digital twin in comparison with the capture images of the non-conforming object.

Referring now to FIG. 3C, shown is an example second object 305 that was generated using 3D printable instruction for altering a non-conforming object 301, in accordance with embodiments of the present disclosure. As shown, the second object 305 (shim or wedge) is placed under the non-conforming leg of the bookshelf to mitigate the non-conformance. For example, the second object 305 was printed to alter and/or reduce non-conformance related to various angles/levelness/tilt related to a floor (the shelf and books are no longer tilting as a result of the ameliorative solution). In some embodiments, the user may recapture images of the non-conforming object once the second object 305 has been used to modify the non-conforming object. The 3D object analysis device 303 then can reanalyze the non-conforming object to determine it is still non-conforming (e.g., comparing new angles/alignments/parts, etc. to the conformance threshold to determine whether conformance has been met). If differences between the recaptured non-conforming object still exceed conformance threshold, then further objects and/or alteration to the non-conforming object can be made until conformance is met.

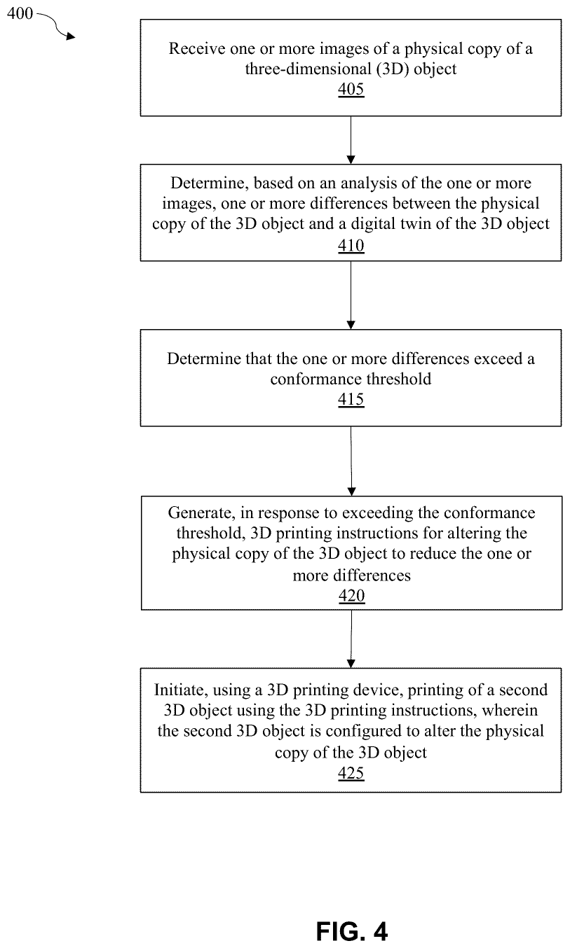

Referring now to FIG. 4, shown is a flow diagram of an example process 400 for generating 3D printable instructions for altering a non-conforming object, in accordance with embodiments of the present disclosure. The process 400 may be performed by processing logic that comprises hardware (e.g., circuitry, dedicated logic, programmable logic, microcode, etc.), software (e.g., instructions run on a processor), firmware, or a combination thereof. In some embodiments, the process 400 is a computer-implemented process. In embodiments, the process 400 may be performed by processor 106 of 3D object analysis device 102 exemplified in FIG. 1.

The process 400 begins by receiving one or more images of a physical copy of a three-dimensional (3D) object. This is illustrated at step 405. The images may be any type of image content depicting the physical copy of the 3D object such as 3D scans, video, and/or static images taken from an image capture device (e.g., 3D scanner, smartphone, table, camera, and the like). For example, a user may generate images (still or video) of a physical object using a smartphone from various angles and upload those images to the system. For example, a facility manager may notice that some computer hardware racks are unlevel and/or unbalanced due to defective components, creating a safety and/or hazard risk. The facility manager may take images of the hardware racks from different angles and upload those to be analyzed by the 3D object analysis device.

The process 400 continues by determining, based on an analysis of the one or more images, one or more differences between the physical copy of the 3D object and a digital twin of the 3D object. This is illustrated at step 410. For example, the 3D object analysis device may utilize various image recognition algorithms or computer vision techniques to identify what type of object is captured in the one or more images and search a digital twin corpus or knowledgebase comprising of a plurality of digital twins to identify a same or substantially similar object. For example, using image recognition, the 3D object analysis device will identify that the object in the images is a computer hardware rack and search a digital twin corpus for a matching computer hardware rack. In some embodiments, this may be based on various attributes within the image such as object type, shape, dimensions, presence of serial numbers, etc. Once the physical object is identified, and a matching digital twin is found, the 3D object analysis device will analyze the difference between the actual state of the physical object in the images in comparison with the perfect state of the object form the digital twin.

In embodiments, the 3D object analysis device will use image recognition algorithms to extract various features or attributes of the non-conforming object and compare those features/attributes to the features/attributes of the digital twin of the object. The features may include, for example, angles and positioning of certain components (e.g., angle tilt in relation to a floor, loose parts, levelness with the ground), the presence of defects (e.g., dents, damaged areas, wear, missing parts or components, etc.), color and/or type of material used to construct the object. As would be recognized by one of ordinary skill in the art, other features may be extracted depending on the type of object, and the examples given herein should not be construed as limiting. The 3D object analysis device may determine how the features of the physical object in its actual state correspond/compare to the features of the digital twin of the object in the perfect state. Based on the comparison, the 3D object analysis device will identify one or more differences between the non-conforming object and the digital twin of the object. Returning to the example, the 3D object analysis device will identify that the unlevel rack in its actual state is missing one or more leveling feet based on a comparison with the digital twin of the computer hardware rack in a perfect state.

The process 400 continues by determining that the one or more differences exceed a conformance threshold. This is illustrated at step 415. For example, the system may include various thresholds for determining which features/attributes of the given object are non-conforming with respect to features/attributes of the digital twin. This may include attributes related to angle, tilt, one or more missing objects or parts, color, etc. For example, the 3D object analysis device may compare the features/attributes related to tilt/angle values of the computer hardware rack in relation to the ground in identify that those values exceed a conformance threshold.

The process 400 continues by generating, in response to exceeding the conformance threshold, 3D printing instructions for altering the physical copy of the 3D object to reduce the one or more differences. This is illustrated at step 420. In embodiments, based on the one or more differences/non-conformance, the 3D object analysis device searches the digital twin corpus that includes a plurality of ameliorative solutions for reducing the differences between the non-conforming object and the digital twin of the object. In embodiments, the digital twin corpus may include a plurality of ameliorative solutions or fixes that other users (crowdsourced users) have used to repair or reduce non-conformance of the object or similar objects. In embodiments, the ameliorative solutions may include additional pieces or makeshift components that are not part of the original design of the object. Returning the previous example, the 3D object analysis device may identify that a best ameliorative solution for reducing the differences such that they fall within the conformance threshold is to add a leveling guide or foot to a leg of the computer hardware rack. In some embodiments, the 3D object analysis device may simulate a plurality of ameliorative solutions in relation to the non-conforming object in order to identify the best solution for addressing the non-conformance. Once the best solution is determined, the 3D object analysis device may generate 3D printing instructions for the ameliorative solution.

In some embodiments, the process 400 continues by initiating, using a 3D printing device, printing of a second 3D object (i.e., ameliorative solution) using the 3D printing instructions, wherein the second 3D object is configured to alter the physical copy of the 3D object to reduce the one or more difference below the conformance threshold. This is illustrated at step 425. Returning to the previous example, the 3D object analysis device will initiate 3D printing of the leveling guide to be used to fix the non-conforming computer hardware rack.

In embodiments, the system may utilize crowdsourcing to improve the quality of the ameliorative solutions for fixing non-conforming objects. For example, the system may be configured to receive feedback from users that indicate various ameliorative solutions or second objects (e.g., parts) have failed to address non-conformance over time (e.g., initially fixed the defective product but failed over time). Using the feedback and machine learning, the system can determine areas of the non-conforming object and/or the ameliorate solution that may be altered to permanently prevent further non-conformance. For example, based on the feedback, the system may recommend one or more different printing materials (e.g., based on a tensile strength determination of a set of printing materials, color, type of filament, etc.) to be used when printing the ameliorative solution for fixing the non-conforming object.

In some embodiments, the user may generate additional images of the physical object with the ameliorative solution being applied and send these images to the system for reanalysis. The system will identify if the ameliorative solution has reduced the given differences in order to fall within the conformance threshold. In some embodiments, the system may use machine learning to track ameliorative solutions that have been made for reoccurring specific non-conforming objects and identify if the solution(s) should be permanently implemented within the digital twin specifications of the object. In this way, if a significant number of users are implementing the same ameliorative solutions for a given type of object, the system may automatically update the digital twin to include that given solution. In some embodiments, data content regarding altering the non-conforming object may be shared with the manufacturer of the give object, such that alterations to the design and/or specification of the object may be made.

Referring now to FIG. 5, shown is a high-level block diagram of an example computer system 501 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 501 may comprise one or more CPUs 502, a memory subsystem 504, a terminal interface 512, a storage interface 516, an I/O (Input/Output) device interface 514, and a network interface 518, all of which may be communicatively coupled, directly or indirectly, for inter-component communication via a memory bus 503, an I/O bus 508, and an I/O bus interface 510.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may include one or more levels of on-board cache. In some embodiments, a processor can include at least one or more of, a memory controller, and/or storage controller. In some embodiments, the CPU can execute the processes included herein (e.g., process 300 as described in FIG. 3). In some embodiments, the computer system 501 may be configured as autonomous vehicle management system 100 of FIG. 1.

System memory subsystem 504 may include computer system readable media in the form of volatile memory, such as random-access memory (RAM) 522 or cache memory 524. Computer system 501 may further include other removable/non-removable, volatile/non-volatile computer system data storage media. By way of example only, storage system 526 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory subsystem 504 can include flash memory, e.g., a flash memory stick drive or a flash drive. Memory devices can be connected to memory bus 503 by one or more data media interfaces. The memory subsystem 504 may include at least one program product having a set (e.g., at least one) of program modules that are configured to carry out the functions of various embodiments.

Although the memory bus 503 is shown in FIG. 5 as a single bus structure providing a direct communication path among the CPUs 502, the memory subsystem 504, and the I/O bus interface 510, the memory bus 503 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single units, the computer system 501 may, in some embodiments, contain multiple I/O bus interfaces 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface but receives requests from other computer systems (clients). Further, in some embodiments, the computer system 501 may be implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary.

One or more programs/utilities 528, each having at least one set of program modules 530 may be stored in memory subsystem 504. The programs/utilities 528 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs/utilities 528 and/or program modules 530 generally perform the functions or methodologies of various embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pitslands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Embodiments of the present disclosure may be implemented together with virtually any type of computer, regardless of the platform is suitable for storing and/or executing program code. FIG. 6 shows, as an example, a computing environment 600 (e.g., cloud computing system) suitable for executing program code related to the methods disclosed herein and for circuit design automation. In some embodiments, the computing environment 600 may be the same as or an implementation of the computing environment 100.

Computing environment 600 contains an example of an environment for the execution of at least some of the computer code involved in performing the inventive methods, such as 3D object analysis code 700. The 3D object analysis code 700 may be a code-based implementation of the autonomous vehicle management system 100. In addition to 3D object analysis code 700, computing environment 600 includes, for example, a computer 601, a wide area network (WAN) 602, an end user device (EUD) 603, a remote server 604, a public cloud 605, and a private cloud 606. In this embodiment, the computer 601 includes a processor set 610 (including processing circuitry 620 and a cache 621), a communication fabric 611, a volatile memory 612, a persistent storage 613 (including operating a system 622 and the 3D object analysis code 700, as identified above), a peripheral device set 614 (including a user interface (UI) device set 623, storage 624, and an Internet of Things (IoT) sensor set 625), and a network module 615. The remote server 604 includes a remote database 630. The public cloud 605 includes a gateway 640, a cloud orchestration module 641, a host physical machine set 642, a virtual machine set 643, and a container set 644.

The computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 630. As is well understood in the art of computer technology, and depending upon the technology, performance of a computer-implemented method may be distributed among multiple computers and/or between multiple locations. On the other hand, in this presentation of the computing environment 600, detailed discussion is focused on a single computer, specifically the computer 601, to keep the presentation as simple as possible. The computer 601 may be located in a cloud, even though it is not shown in a cloud in FIG. 1. On the other hand, the computer 601 is not required to be in a cloud except to any extent as may be affirmatively indicated.

The processor set 610 includes one, or more, computer processors of any type now known or to be developed in the future. The processing circuitry 620 may be distributed over multiple packages, for example, multiple, coordinated integrated circuit chips. The processing circuitry 620 may implement multiple processor threads and/or multiple processor cores. The cache 621 is memory that is located in the processor chip package(s) and is typically used for data or code that should be available for rapid access by the threads or cores running on the processor set 610. Cache memories are typically organized into multiple levels depending upon relative proximity to the processing circuitry. Alternatively, some, or all, of the cache for the processor set may be located “off chip.” In some computing environments, the processor set 610 may be designed for working with qubits and performing quantum computing.

Computer readable program instructions are typically loaded onto the computer 601 to cause a series of operational steps to be performed by the processor set 610 of the computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 621 and the other storage media discussed below. The program instructions, and associated data, are accessed by the processor set 610 to control and direct performance of the inventive methods. In the computing environment 600, at least some of the instructions for performing the inventive methods may be stored in the 3D object analysis code 700 in the persistent storage 613.

The communication fabric 611 is the signal conduction path that allows the various components of the computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 612 is any type of volatile memory now known or to be developed in the future. Examples include dynamic type random access memory (RAM) or static type RAM. Typically, the volatile memory 612 is characterized by random access, but this is not required unless affirmatively indicated. In the computer 601, the volatile memory 612 is located in a single package and is internal to the computer 601, but, alternatively or additionally, the volatile memory may be distributed over multiple packages and/or located externally with respect to the computer 601.

The persistent storage 613 is any form of non-volatile storage for computers that is now known or to be developed in the future. The non-volatility of this storage means that the stored data is maintained regardless of whether power is being supplied to the computer 601 and/or directly to the persistent storage 613. The persistent storage 613 may be a read only memory (ROM), but typically at least a portion of the persistent storage allows writing of data, deletion of data and re-writing of data. Some familiar forms of persistent storage include magnetic disks and solid state storage devices. The operating system 622 may take several forms, such as various known proprietary operating systems or open source Portable Operating System Interface-type operating systems that employ a kernel. The code included in the 3D object analysis code 700 typically includes at least some of the computer code involved in performing the inventive methods.

The peripheral device set 614 includes the set of peripheral devices of the computer 601. Data communication connections between the peripheral devices and the other components of the computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 623 may include components such as a display screen, speaker, microphone, wearable devices (such as goggles and smart watches), keyboard, mouse, printer, touchpad, game controllers, and haptic devices. The storage 624 is external storage, such as an external hard drive, or insertable storage, such as an SD card. The storage 624 may be persistent and/or volatile. In some embodiments, the storage 624 may take the form of a quantum computing storage device for storing data in the form of qubits. In embodiments where the computer 601 is required to have a large amount of storage (for example, where the computer 601 locally stores and manages a large database) then this storage may be provided by peripheral storage devices designed for storing very large amounts of data, such as a storage area network (SAN) that is shared by multiple, geographically distributed computers. The IoT sensor set 625 is made up of sensors that can be used in Internet of Things applications. For example, one sensor may be a thermometer and another sensor may be a motion detector.

The network module 615 is the collection of computer software, hardware, and firmware that allows the computer 601 to communicate with other computers through the WAN 602. The network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 615 are performed on the same physical hardware device. In other embodiments (for example, embodiments that utilize software-defined networking (SDN)), the control functions and the forwarding functions of the network module 615 are performed on physically separate devices, such that the control functions manage several different network hardware devices. Computer readable program instructions for performing the inventive methods can typically be downloaded to the computer 601 from an external computer or external storage device through a network adapter card or network interface included in the network module 615.

The WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 603 is any computer system that is used and controlled by an end user (for example, a customer of an enterprise that operates the computer 601) and may take any of the forms discussed above in connection with the computer 601. The EUD 603 typically receives helpful and useful data from the operations of the computer 601. For example, in a hypothetical case where the computer 601 is designed to provide a recommendation to an end user, this recommendation would typically be communicated from the network module 615 of the computer 601 through the WAN 602 to the EUD 603. In this way, the EUD 603 can display, or otherwise present, the recommendation to an end user. In some embodiments, the EUD 603 may be a client device, such as thin client, heavy client, mainframe computer, desktop computer and so on.

The remote server 604 is any computer system that serves at least some data and/or functionality to the computer 601. The remote server 604 may be controlled and used by the same entity that operates computer 601. The remote server 604 represents the machine(s) that collect and store helpful and useful data for use by other computers, such as the computer 601. For example, in a hypothetical case where the computer 601 is designed and programmed to provide a recommendation based on historical data, then this historical data may be provided to the computer 601 from the remote database 630 of the remote server 604.

The public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 605 is performed by the computer hardware and/or software of the cloud orchestration module 641. The computing resources provided by the public cloud 605 are typically implemented by virtual computing environments that run on various computers making up the computers of the host physical machine set 642, which is the universe of physical computers in and/or available to the public cloud 605. The virtual computing environments (VCEs) typically take the form of virtual machines from the virtual machine set 643 and/or containers from the container set 644. It is understood that these VCEs may be stored as images and may be transferred among and between the various physical machine hosts, either as images or after instantiation of the VCE. The cloud orchestration module 641 manages the transfer and storage of images, deploys new instantiations of VCEs and manages active instantiations of VCE deployments. The gateway 640 is the collection of computer software, hardware, and firmware that allows the public cloud 605 to communicate through the WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 606 is similar to the public cloud 605, except that the computing resources are only available for use by a single enterprise. While the private cloud 606 is depicted as being in communication with the WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 605 and the private cloud 606 are both part of a larger hybrid cloud.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. In some embodiments, one or more of the operating system 622 and the 3D object analysis code 700 may be implemented as service models. The service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
receiving one or more images of a physical copy of a three-dimensional (3D) object;
determining, based on an analysis of the one or more images, one or more differences between the physical copy of the 3D object and a digital twin of the 3D object;
determining that the one or more differences exceed a conformance threshold; and
generating, in response to exceeding the conformance threshold, 3D printing instructions for altering the physical copy of the 3D object to reduce the one or more differences.

2. The method of claim 1, further comprising:
initiating, using a 3D printing device, printing of a second 3D object using the 3D printing instructions, wherein the second 3D object is configured to alter the physical copy of the 3D object to reduce the one or more difference below the conformance threshold.

3. The method of claim 1, wherein determining the one or more differences between the physical copy of the 3D object and the digital twin of the 3D object comprises:
analyzing, using image recognition, the one or more images of the physical copy of the 3D object to identify a type of object;
searching a digital twin corpus of a plurality of 3D objects to identify one or more objects that closely match the type of object;
selecting, in response to meeting a similarly threshold, the digital twin of the 3D object from the plurality of 3D objects; and
analyzing a first set of attributes associated with the physical copy of the 3D object and a second set of attributes associated with the digital twin of the 3D object, wherein a value of at least one attribute of the first set of attributes is different from a value of at least one of the second set of attributes.

4. The method of claim 1, wherein generating the 3D printing instructions for altering the physical copy of the 3D object to reduce the one or more differences comprises:
searching a digital twin corpus that includes a plurality of ameliorative solutions used to reduce the one or more differences of similar non-conforming objects;
selecting the ameliorative solution from the plurality of ameliorative solutions that has a highest score for reducing the one or more differences of similar non-conforming objects; and
generating, the 3D printing instructions for alerting the physical copy of the 3D object based on the selected ameliorative solution.

5. The method of claim 4, wherein the plurality of ameliorative solutions is based in part on crowdsourced ameliorative solutions received from a plurality of other users.

6. The method of claim 4, wherein selecting the ameliorative solution from the plurality of ameliorative solutions comprises:
generating simulations of the physical copy of the 3D object with each ameliorative solution of the plurality of ameliorative solutions applied to the physical object to reduce the one or more differences;
analyzing changes in the one or more differences as a result of applying each ameliorative solution; and
selecting the ameliorative solution that has a highest value for reducing the one or more differences.

7. The method of claim 1, further comprising:
receiving feedback from one or more users indicating that the 3D printing instructions for altering the physical copy of the 3D object reduced the one or more differences;
determining, based on the feedback, an area of the physical object to modify; and
updating, in response to the determining, the digital twin of the 3D object with the modification to the area.

8. A system comprising:
a processor; and
a computer-readable storage medium communicatively coupled to the processor and storing program instructions which, when executed by the processor, cause the processor to perform a method comprising:
receiving one or more images of a physical copy of a three-dimensional (3D) object;
determining, based on an analysis of the one or more images, one or more differences between the physical copy of the 3D object and a digital twin of the 3D object;
determining that the one or more differences exceed a conformance threshold; and
generating, in response to exceeding the conformance threshold, 3D printing instructions for altering the physical copy of the 3D object to reduce the one or more differences.

9. The system of claim 8, wherein the method performed by the processor further comprises:
initiating, using a 3D printing device, printing of a second 3D object using the 3D printing instructions, wherein the second 3D object is configured to alter the physical copy of the 3D object to reduce the one or more difference below the conformance threshold.

10. The system of claim 8, wherein determining the one or more differences between the physical copy of the 3D object and the digital twin of the 3D object comprises:
analyzing, using image recognition, the one or more images of the physical copy of the 3D object to identify a type of object;
searching a digital twin corpus of a plurality of 3D objects to identify one or more objects that closely match the type of object;
selecting, in response to meeting a similarly threshold, the digital twin of the 3D object from the plurality of 3D objects; and
analyzing a first set of attributes associated with the physical copy of the 3D object and a second set of attributes associated with the digital twin of the 3D object, wherein a value of at least one attribute of the first set of attributes is different from a value of at least one of the second set of attributes.

11. The system of claim 8, wherein generating the 3D printing instruction for altering the physical copy of the 3D object to reduce the one or more differences comprises:
searching a digital twin corpus that includes a plurality of ameliorative solutions used to reduce the one or more differences of similar non-conforming objects;
selecting the ameliorative solution from the plurality of ameliorative solutions that has a highest score for reducing the one or more differences of similar non-conforming objects; and
generating, the 3D printing instructions for alerting the physical copy of the 3D object based on the selected ameliorative solution.

12. The system of claim 11, wherein the plurality of ameliorative solutions is based in part on crowdsourced ameliorative solutions received from a plurality of other users.

13. The system of claim 11, wherein selecting the ameliorative solution from the plurality of ameliorative solutions comprises:
generating simulations of the physical copy of the 3D object with each ameliorative solution of the plurality of ameliorative solutions applied to the physical object to reduce the one or more differences;
analyzing changes in the one or more differences as a result of applying each ameliorative solution; and
selecting the ameliorative solution that has a highest value for reducing the one or more differences.

14. The system of claim 8, wherein the method performed by the processor further comprises:
receiving feedback from one or more users indicating that the 3D printing instructions for altering the physical copy of the 3D object reduced the one or more differences;
determining, based on the feedback, an area of the physical object to modify; and
updating, in response to the determining, the digital twin of the 3D object with the modification to the area.

15. A computer program product comprising a computer-readable storage medium having program instructions embodied therewith, the program instructions executable by a processor to cause the processor to perform a method comprising:
receiving one or more images of a physical copy of a three-dimensional (3D) object;
determining, based on an analysis of the one or more images, one or more differences between the physical copy of the 3D object and a digital twin of the 3D object;
determining that the one or more differences exceed a conformance threshold; and
generating, in response to exceeding the conformance threshold, 3D printing instruction for altering the physical copy of the 3D object to reduce the one or more differences.

16. The computer program product of claim 15, wherein the method performed by the processor further comprises:
initiating, using a 3D printing device, printing of a second 3D object using the 3D printing instructions, wherein the second 3D object is configured to alter the physical copy of the 3D object to reduce the one or more difference below the conformance threshold.

17. The computer program product of claim 15, wherein determining the one or more differences between the physical copy of the 3D object and the digital twin of the 3D object comprises:
analyzing, using image recognition, the one or more images of the physical copy of the 3D object to identify a type of object;
searching a digital twin corpus of a plurality of 3D objects to identify one or more objects that closely match the type of object;
selecting, in response to meeting a similarly threshold, the digital twin of the 3D object from the plurality of 3D objects; and
analyzing a first set of attributes associated with the physical copy of the 3D object and a second set of attributes associated with the digital twin of the 3D object, wherein a value of at least one attribute of the first set of attributes is different from a value of at least one of the second set of attributes.

18. The computer program product of claim 15, wherein generating the 3D printing instructions for altering the physical copy of the 3D object to reduce the one or more differences comprises:
searching a digital twin corpus that includes a plurality of ameliorative solutions used to reduce the one or more differences of similar non-conforming objects;
selecting the ameliorative solution from the plurality of ameliorative solutions that has a highest score for reducing the one or more differences of similar non-conforming objects; and
generating, the 3D printing instructions for alerting the physical copy of the 3D object based on the selected ameliorative solution.

19. The computer program product of claim 18, wherein the plurality of ameliorative solutions is based in part on crowdsourced ameliorative solutions received from a plurality of other users.

20. The computer program product of claim 18, wherein selecting the ameliorative solution from the plurality of ameliorative solutions comprises:
generating simulations of the physical copy of the 3D object with each ameliorative solution of the plurality of ameliorative solutions applied to the physical object to reduce the one or more differences;
analyzing changes in the one or more differences as a result of applying each ameliorative solution; and
selecting the ameliorative solution that has a highest value for reducing the one or more differences.
